(19) United States
(12) Patent Application Publication
(10) Pub. No.: US 2026/0367740 A1
(43) Pub. Date: Nov. 19, 2026

(54) STIMULUS CONTROL DEVICE, STIMULUS CONTROL METHOD AND STIMULUS PRESENTER

(71) Applicant: NTT, Inc., Tokyo (JP)

(72) Inventor: Tao MORISAKI, Tokyo (JP)

(21) Appl. No.: 19/515,814

(22) PCT Filed: Sep. 8, 2023
(86) PCT No.: PCT/JP2023/032858

§ 371 Date: Mar. 3, 2026

(51) Int. Cl. G06F 3/043

(52) U.S. Cl. CPC G06F 3/043

(57) ABSTRACT

An aspect of the present invention is a stimulation control device which includes an ultrasonic irradiator which emits ultrasonic waves to a stimulation presenter including a sound-absorbing material which is a passive one and absorbs ultrasonic waves and releases heat, and a displacement body which is a passive one and is at least partially displaced upon receiving the ultrasonic waves; and a control unit which controls operation of the ultrasonic irradiator, in which the control unit controls operation of the ultrasonic irradiator to irradiate the sound-absorbing material with the ultrasonic waves in a partial period of a predetermined unit period and to irradiate the displacement body with the ultrasonic waves in another partial period of the unit period.

### TECHNICAL FIELD

The present invention relates to a stimulus control device, a stimulus control method, and a stimulus presenter.

### BACKGROUND ART

With increased interest in haptic technology, there is a need for tactile displays that are more lightweight and can be used without the burden of attachment. Passive tactile devices which do not require a battery or wiring have been proposed as lightweight and easy-to-use devices. Passive means that stimulation can be presented to a presentation target without using a power source or a wiring. In particular, an ultrasound-driven approach is promising, and technologies have been proposed to present several hundred mN forces and 2 to 30 Hz low frequency vibrations using plastic devices weighing several grams by amplifying the radiation force of the ultrasound with a lever mechanism (see NPL 1). Also proposed is a technology for presenting thermal stimulation by irradiating a sound-absorbing material such as a fabric with ultrasonic waves (see NPL 2).

### CITATION LIST

### Non Patent Literature

[NPL 1] Morisaki et al., “Ultrasound-Driven Passive Haptic Actuator Based on Amplifying Radiation Force Using Simple Lever Mechanism,” SIGGRAPH Asia 2022, Emerging Technologies, 2022.

[NPL 2] Kamigaki et al., “Noncontact Thermal and Vibrotactile Display using Focused Airborne Ultrasound,” International Conference on Human Haptic Sensing and Touch Enabled Computer Applications (Eurohaptics), 2020.

### SUMMARY OF INVENTION

### Technical Problem

In order to reproduce the tactile sensation of human skin, hot water, and the like, it is necessary to present both temperature and force, that is, heat and mechanical stimulation. However, there has not been proposed a technology for presenting heat and mechanical stimulation in an ultrasound-driven (not including power supply and wiring) passive haptic device, as described above. Although structures for presenting a mechanical and thermal stimulation have been proposed as described above, there is no way to drive them simultaneously within the range of practical acoustic power (for example, 10 W) .

In view of the above circumstances, an object of the present invention is to provide a technology for presenting heat and mechanical stimulation using a passive one which is driven by ultrasound waves.

### Solution to Problem

An aspect of the present invention is a stimulation control device which includes an ultrasonic irradiator which emits ultrasonic waves to a stimulation presenter including a sound-absorbing material which is a passive one and absorbs ultrasonic waves and releases heat, and a displacement body which is a passive one and is at least partially displaced upon receiving the ultrasonic waves; and a control unit which controls operation of the ultrasonic irradiator, in which the control unit controls operation of the ultrasonic irradiator to irradiate the sound-absorbing material with the ultrasonic waves in a partial period of a predetermined unit period and to irradiate the displacement body with the ultrasonic waves in another partial period of the unit period.

An aspect of the present invention is a stimulation control method executed by a stimulation control device which includes an ultrasonic irradiator which emits ultrasonic waves to a stimulation presenter including a sound-absorbing material which is a passive one and absorbs ultrasonic waves and releases heat, and a displacement body which is a passive one and is at least partially displaced upon receiving the ultrasonic waves; and a control unit which controls operation of the ultrasonic irradiator, in which the control unit has a control system which controls operation of the ultrasonic irradiator to irradiate the sound-absorbing material with the ultrasonic waves in a partial period of a predetermined unit period and to irradiate the displacement body with the ultrasonic waves in another partial period of the unit period.

An aspect of the present invention is a stimulation presenter which includes a sound-absorbing material which is a passive one and absorbs ultrasonic waves and releases heat; and a displacement body which is a passive one and is at least partially displaced upon receiving the ultrasonic waves.

### Advantageous Effects of Invention

According to the present invention, heat and mechanical stimulation can be presented by a passive one which is driven by ultrasound waves.

### BRIEF DESCRIPTION OF DRAWINGS

FIG. 1 is an explanatory diagram explaining a stimulation system of an embodiment.

FIG. 2 is an explanatory diagram explaining an example of the configuration of the stimulation system of the embodiment.

FIG. 3 is an explanatory diagram explaining a first example of control by time division control processing in the embodiment.

FIG. 4 is an explanatory diagram explaining a second example of control by time division control processing in the embodiment.

FIG. 5 is a first diagram showing an example of experimental results in the embodiment.

FIG. 6 is a second diagram showing an example of experimental results in the embodiment.

FIG. 7 is a diagram showing a more detailed example of a hardware configuration of a stimulation control device 1 in the embodiment.

FIG. 8 is a diagram showing an example of the processing flow executed by the stimulation control device 1 in the embodiment.

FIG. 9 is a diagram showing an example of a configuration of a stimulation system of a modified example.

### DESCRIPTION OF EMBODIMENTS

### Embodiment

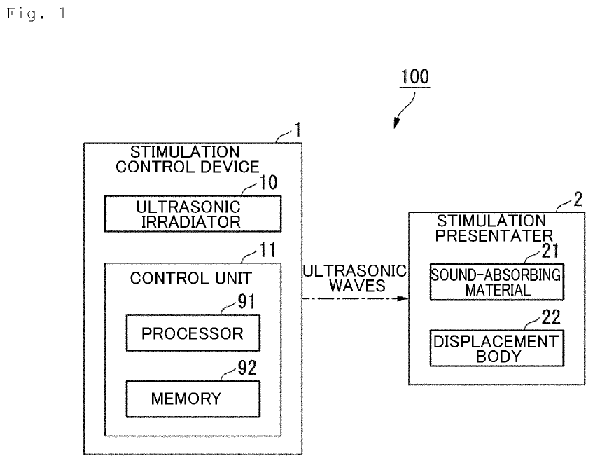

FIG. 1 is an explanatory diagram which explains a stimulation system 100 of an embodiment. The stimulation system 100 includes a stimulation control device 1 and a stimulation presenter 2. The stimulation control device 1 includes an ultrasonic irradiator 10, and irradiates the stimulation presenter 2 with ultrasonic waves by the ultrasonic irradiator 10.

More specifically, the stimulation control device 1 includes an ultrasonic irradiator 10, and a control unit 11 that includes a processor 91, such as a central processing unit (CPU), a graphics processing unit (GPU) or a neural network processing unit (NPU), and a memory 92, which are connected by a bus. The ultrasonic irradiator 10 is controlled by the control unit 11 to irradiate the stimulation presenter 2 with ultrasonic waves.

The ultrasonic irradiator 10 is, for example, an aggregate of ultrasound vibrators. Accordingly, the ultrasonic irradiator 10 is, for example, an ultrasonic phased array. The ultrasonic phased array is capable of changing the intensity and propagation destination of the emitted ultrasonic waves.

Specifically, the intensity, waveform, and propagation destination of the ultrasonic waves emitted by the ultrasonic phased array change, by changing the intensity and phase of the emitted ultrasonic waves for each ultrasonic vibrator included in the ultrasonic phased array. The change in the propagation destination of the ultrasonic waves means the change in the position of the focal point of the ultrasonic waves. Further, the distribution of the sound pressure of the presentation target may not be a focal point, and specifically, may present a multi-focal point or a plane wave.

The intensity of the ultrasonic waves may be any amount as long as it indicates the energy carried by the ultrasonic waves. Accordingly, the intensity of the ultrasonic waves may be, for example, the energy of the ultrasound, or the amplitude of a sine wave if the waveform of the ultrasound is a sine wave. If the waveform of the ultrasonic waves is a non-sine wave such as a Gaussian function, the intensity of the ultrasonic waves may be a maximum value of the amplitude of the waveform.

The stimulation presenter 2 includes a sound-absorbing material 21 and a displacement body 22. The sound-absorbing material 21 is a passive one that absorbs ultrasonic waves and releases heat. Passive means that stimulation can be presented to the presentation target without using any power source or wiring. Passive one means something that stimulation can be presented to the presentation target without using a power source or wiring.

The sound-absorbing material 21 is a passive one that absorbs ultrasonic waves and releases heat. The sound-absorbing material 21 may be any passive one that absorbs ultrasonic waves and releases heat, for example, a fabric. Fabric is an example of a passive one which is driven by ultrasonic waves because it can absorb ultrasound and release heat without a power source or wiring.

The displacement body 22 is a passive one which is at least partially displaced by receiving ultrasonic waves. When there is an object at a displacement destination of the displacement body 22, the object and the displacement body 22 come into contact with each other. The contact gives a mechanical stimulation to the object of the displacement destination.

Accordingly, when the stimulation presenter 2 is attached to a presentation target of stimulation such as a human or animal, the stimulation presenter 2 irradiated with the ultrasonic waves by the stimulation control device 1 presents heat and mechanical stimulation to the presentation target. The mechanical stimulation is a force.

The displacement body 22 is, for example, a passive vibrator that vibrates upon receiving ultrasonic waves. When the displacement body 22 is the vibrator, stimulation by vibration of the vibrator is an example of mechanical stimulation. When the displacement body 22 is the vibrator, the magnitude of the displacement is the magnitude of the amplitude of the vibration.

The displacement body 22 may be, for example, one that gives stimulation to the presentation target on the principle of leverage. Specifically, what gives stimulation to the presentation target on the principle of leverage is a passive one which has a portion functioning as a fulcrum, a portion functioning as a point of action, and a portion functioning as a point of force, and in which the presentation target is located at a displacement destination of the point of action and the position of the point of force is irradiated with ultrasound. Since the position of the point of force may be irradiated with the ultrasonic waves, for example, the position of the point of force may be the focal point of the ultrasonic waves.

When the point of force is irradiated with the ultrasonic waves, because the force of the ultrasonic waves is applied to the point of force, the position of the application point is displaced. As a result, force is applied to the presentation target located at the displacement destination of the point of action. The force exerted on the presentation target in this manner is an example of mechanical stimulation. As described above, a passive one that gives stimulation to the presentation target on the principle of leverage is an example of a passive one which is driven by ultrasonic waves, because it can receive ultrasonic waves and present mechanical stimulation without using a power source or wiring.

If the displacement body 22 is a passive one that gives stimulation to the presentation target on the principle of leverage, the displacement body 22 may be a rigid body of a predetermined intensity, for example, such as a plastic bar, as long as it can give stimulation to the presentation target passive on the principle of leverage.

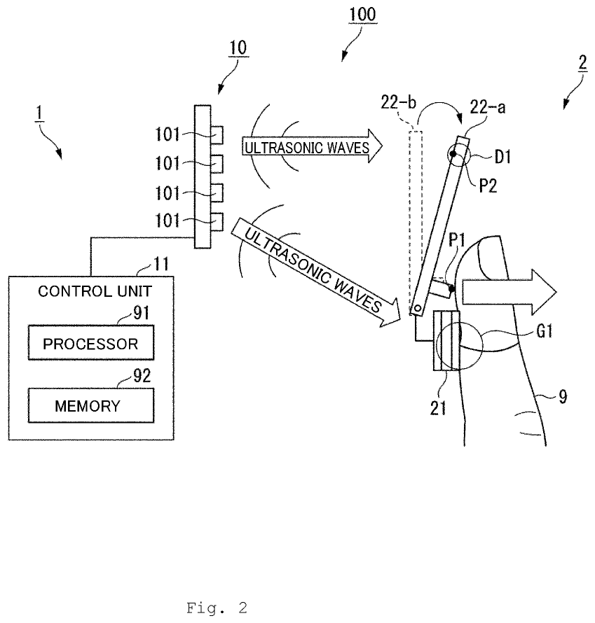

FIG. 2 is an explanatory diagram which explains an example of a configuration of the stimulation system 100 of the embodiment. More specifically, FIG. 2 shows an example of the configuration of the stimulation control device 1 and the stimulation presenter 2.

FIG. 2 shows a displacement body 22-a and a displacement body 22-b as examples of the displacement body 22. The displacement body 22-a is an example of the displacement body 22 after displacement by the irradiation of ultrasonic waves. The displacement body 22-b is an example of the displacement body 22, and is an example of the displacement body 22 which is the displacement body 22-a after displacement.

In the example of FIG. 2, the displacement body 22 is a passive one that stimulates the presentation target on the principle of leverage. FIG. 2 shows that the sound-absorbing material 21 and the displacement body 22 are attached to a finger of a presentation target 9.

Point P1 of FIG. 2 is an example of a point of action, and point P2 is an example of a point of force. Region D1 pf FIG. 2 shows a spatial region being irradiated with ultrasonic waves In the example of FIG. 2, since the point P2 is located in the region D1, the point P1 is displaced by the irradiation of the ultrasonic waves to the displacement body 22, and the mechanical stimulation is applied to the presentation target.

An image G1 of FIG. 2 shows the heat emitted by the sound-absorbing material 21 as a result of the ultrasonic waves being applied to the sound-absorbing material 21.

FIG. 2 also shows an example of the configuration of the ultrasonic irradiator 10. The ultrasonic irradiator 10 includes a plurality of ultrasonic vibrators 101. Each ultrasonic irradiator 101 is controlled by the control unit 11.

FIG. 1 will be described again. The control unit 11 controls the operation of the ultrasonic irradiator 10 to change the intensity, waveform, and propagation destination of the ultrasonic waves emitted by the ultrasonic irradiator 10. The control unit 11 performs the time division control processing. The time division control processing is a process for controlling the operation of the ultrasonic irradiator 10 so that the sound-absorbing material 21 is irradiated with ultrasonic waves in a partial period in a unit period that is a predetermined period and the displacement body 22 is irradiated with ultrasonic waves in another partial period in the unit period.

The irradiation of the ultrasonic waves toward the sound-absorbing material 21 means that the ultrasonic waves are emitted so that the focal points of the ultrasonic waves are located on the sound-absorbing material 21. Irradiating of the ultrasonic waves toward the displacement body 22 meant that the ultrasound is emitted such that the focal points of the ultrasonic waves are located on the displacement body 22.

By the time division control processing, for example, ultrasonic waves are emitted toward the displacement body 22 during a period of ⅓ of a unit period, and ultrasonic waves are emitted toward the sound-absorbing material 21 during a remaining period of the unit period (i.e., a period of ⅔ of the unit period).

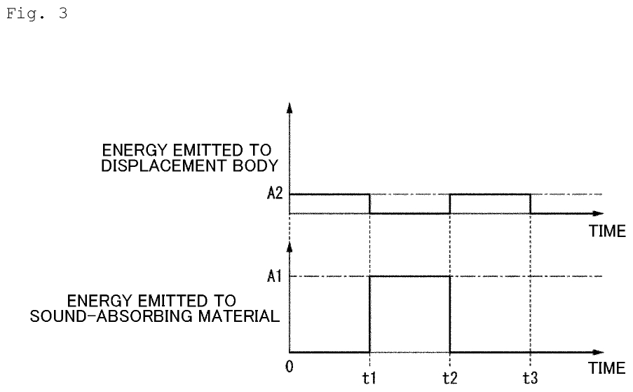

FIG. 3 is an explanatory diagram for explaining a first example of control by the time division control processing in the embodiment. FIG. 3 shows an aspect in which ultrasonic waves are emitted from the ultrasonic irradiator 10 to the sound-absorbing material 21 and the displacement body 22 at a duty ratio of 0.5 by executing the time division control processing.

Specifically, the displacement body 22 is irradiated with the ultrasonic waves from a time origin to a time t1, the sound-absorbing material 21 is irradiated with the ultrasonic waves from the time t1 to a time t2, and the displacement body 22 is irradiated with the ultrasonic waves from the time t2 to a time t3. A length of time from the time origin to the time t1, a length of time from the time t1 to the time t2, and a length of time from the time t2 to the time t3 are the same.

A period from the time origin to the time t2 is an example of the unit period.

FIG. 3 shows that both the sound-absorbing material 21 and the displacement body 22 are also irradiated with rectangular waves. FIG. 3 shows that there is a difference in the maximum value of instantaneous value of energy between the sound-absorbing material 21 and the displacement body 22. Specifically, FIG. 3 shows that a maximum value A2 of the instantaneous value of the displacement body 22 is smaller than a maximum value A1 of the instantaneous value of the sound-absorbing material 21.

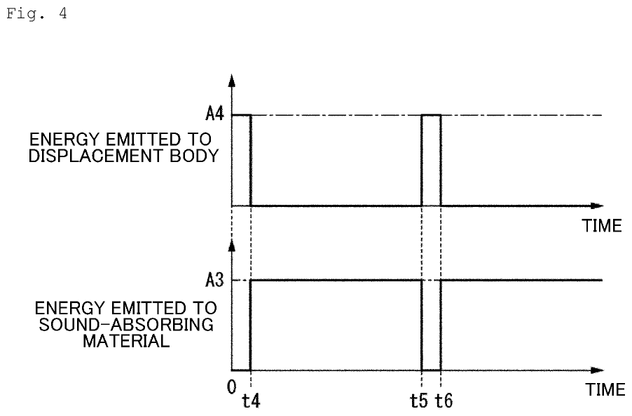

FIG. 4 is an explanatory diagram which explains a second example of control by the time division control processing in the embodiment. FIG. 4 shows an aspect in which ultrasonic waves are emitted from the ultrasonic irradiator 10 to the sound-absorbing material 21 and the displacement body 22 at a duty ratio of 0.1 by executing the time division control processing.

Specifically, the displacement body 22 is irradiated with the ultrasonic waves from the time origin to a time t4, the sound-absorbing material 21 is irradiated with the ultrasonic waves from the time t4 to a time t5, and the displacement body 22 is irradiated with the ultrasonic waves from the time t5 to a time t6. A length of time from time t1 to time t2 is nine times the length of time from time origin to time t1.

A period from the time origin to the time t6 is an example of the unit period.

FIG. 4 shows that both the sound-absorbing material 21 and the displacement body 22 are irradiated with rectangular waves.

FIG. 4 shows that the maximum value of instantaneous value of energy is the same for the sound-absorbing material 21 and the displacement body 22. Specifically, FIG. 4 shows that the maximum value A4 of the instantaneous value of the displacement body 22 is the same as the maximum value A3 of the instantaneous value of the sound-absorbing material 21.

Even when the duty ratio is 0.9, the maximum value of the instantaneous value of the displacement body 22 and the maximum value of the instantaneous value of the sound-absorbing material 21 need not necessarily be the same. The maximum value of the instantaneous value of the displacement body 22 may be smaller than or larger than the maximum value of the instantaneous value of the sound-absorbing material 21. When the duty ratio is 0.1, the maximum value of the instantaneous value of the displacement body 22 and the maximum value of the instantaneous value of the sound-absorbing material 21 may be the same, or the maximum value of the instantaneous value of the displacement body 22 may be larger than the maximum value of the instantaneous value of the sound-absorbing material 21. All the instantaneous values of FIGS. 3 and 4 are examples.

The duty ratio may be any duty ratio and does not necessarily need to be 0.5 or 0.1. In any case of the duty ratios, the maximum value of the instantaneous value of the displacement body 22 and the maximum value of the instantaneous value of the sound-absorbing material 21 may be the same or different.

In the examples shown in FIGS. 3 and 4, the sound-absorbing material 21 and the displacement body 22 are irradiated with rectangular waves, but the waveforms of the ultrasonic waves do not necessarily need to be rectangular waves. For example, the waveform may be a Gaussian waveform. The waveforms of FIGS. 3 and 4 are both examples.

### Effects of Time Division Control Processing

The effects of the time division control processing will be described. A technology of continuously irradiating the sound-absorbing material 21 and the displacement body 22 with ultrasonic waves at the same time (hereinafter referred to as “space division control”) can be provided to cause the stimulation presenter 2 to present heat and mechanical stimulation, That is, a technology of simultaneously positioning the focal points of the ultrasonic waves on the sound-absorbing material 21 and the displacement body 22 can be provided to cause the stimulation presenter 2 to present heat and mechanical stimulation. Even in this case, the sound-absorbing material 21 radiates heat, and the displacement body 22 can give mechanical stimulation to the presentation target.

As an application example of the space division control, for example, a case is considered in which, of the amount of energy emitted by the ultrasonic irradiator 10 in a unit period, the sound-absorbing material 21 is irradiated with Pa 1% and the displacement body 22 is irradiated with Pa 2%. If the ultrasonic irradiator 10 always irradiates the sound-absorbing material 21 and the displacement body 22 with ultrasonic waves at the same time with this energy distribution, the displacement of the displacement body 22 continues to be a constant displacement according to the energy of Pa 2%, while receiving the ultrasonic waves.

Consider a situation in which the time division control processing is executed. The sound-absorbing material 21 is irradiated with the ultrasonic waves during a period of Pa 3% of the unit period, and the displacement body 22 is irradiated during a period of Pa 4% which is the remaining period. Pa4 is smaller than Pa2. A total amount of energy emitted by the ultrasonic irradiator 10 in a unit period is equal to a total amount in the case of space division control. In this case, the displacement body 22 is irradiated with a Pa 4% energy less than that in the case of the space division control.

However, the displacement body 22 can give a Pa4/Pa2 times or more mechanical stimulation to the presentation target. The reason will be described below.

One of the differences between the events occurring in the case of time division control processing and the events occurring in the case of space division control is whether damping of the magnitude of displacement occurs with time. In the case of the time division control processing and in the case of the space division control, the displacement at the moment the displacement body 22 receives energy may be substantially the same.

As an example, the ultrasonic waves of a pulse wave with a maximum value of M is compared with a continuous wave (CW) wave with a maximum value of M. In this case, the maximum displacement of the displacement body 22 is the timing when the amplitude of the wave reaching the displacement body 22 is the maximum value M. Accordingly, the displacement occurring at this timing is approximately the same in either the pulse wave or the CW wave. Of course, the magnitude of the displacement due to the pulse wave is attenuated over time, unlike the displacement due to the CW wave. However, as the instantaneous values, neither the displacement due to the pulse wave nor the displacement due to the CW wave are similar.

Also, in practice, the strong mechanical stimulation for the presentation target does not need to be continuous, and may be a strong mechanical stimulation instantaneously. Therefore, from the viewpoint of presenting the mechanical stimulation to the presentation target, it is not necessary to be continuous mechanical stimulation by the space division control, and it may be temporary mechanical stimulation by the time division control processing.

In this way, by execution the time division control processing, it is possible to reduce the energy required to give mechanical stimulation. As a result, energy given to the sound-absorbing material 21 can be increased. Of course, the amount of energy applied to the sound-absorbing material 21 may be the same as that in the case of the space division control. In this case, since the total amount of energy emitted by the ultrasonic irradiator 10 is reduced, energy consumption required for presenting the stimulation to the presentation target is reduced.

### Experimental Results

Since it was confirmed by experiments that the above-described effects were produced, an example of the results of the experiments will now be described. In the experiment, the sound-absorbing material 21 was irradiated with rectangular waves having a predetermined duty ratio by executing the time division control processing. In the experiment, the heat emitted by the sound-absorbing material 21 was measured by a thermocouple. Further, in the experiment, the magnitude of the displacement of the displacement body 22 was estimated by simulation of vibration characteristics, using the measurement results of the thermocouple.

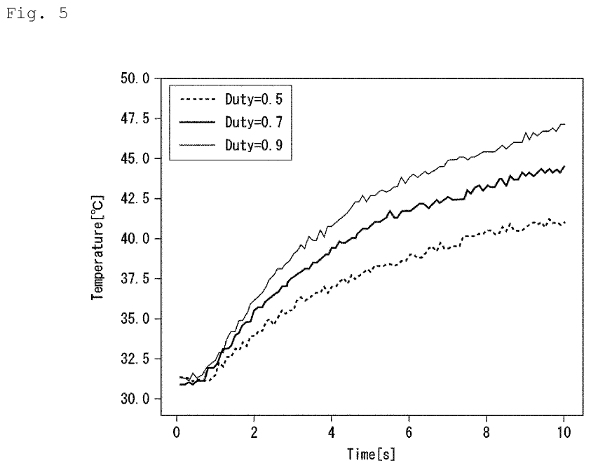

FIG. 5 is a first diagram showing an example of experimental results in the embodiment. More specifically, FIG. 5 shows the time change in temperature measured by the thermocouple for each case of the duty ratios of 0.5, 0.7, and 0.9. In the experiments, the frequency of ultrasonic waves was 5 Hz. horizontal axis of FIG. 5 represents time, and a vertical axis represents temperature. The unit on the horizontal axis is second, and the unit on the vertical axis is Cossius degrees.

In FIG. 5, “duty=0.5” means that the duty ratio in the experiment was 0.5. In the experiment, a duty ratio of 0.5 means that, due to time division control processing, the sound-absorbing material 21 is irradiated with ultrasonic waves during a period of 50% of the unit period, and the displacement body 22 is irradiated with ultrasonic waves during a period of other 50% of the unit period.

In FIG. 5, “duty=0.7” means that the duty ratio in the experiment was 0.7. The duty ratio of 0.7 in the experiment means that, due to the time division control processing, the sound-absorbing material 21 is irradiated with ultrasonic waves during a period of 70% of the unit period, and the displacement body 22 is irradiated with ultrasonic waves during a period of 30% of the unit period.

In FIG. 5, “duty=0.9” means that the duty ratio in the experiment was 0.9. A duty ratio of 0.9 in the experiment means that, due to the time division control processing, the sound-absorbing material 21 is irradiated with ultrasonic waves during a period of 90% of the unit period, the displacement body 22 is irradiated with ultrasonic waves during a period of 10% of the unit period.

The results of FIG. 5 show that the temperature increases over time. The results of FIG. 5 show that the higher the duty ratio is, the higher the rise rate of temperature is.

Furthermore, the results of FIG. 5 show that the heating rate is 3.49 degrees/second or more when the duty ratio is 0.7 and 0.9. This indicates that the stimulation system 100 can present heat to the presentation target at high speed.

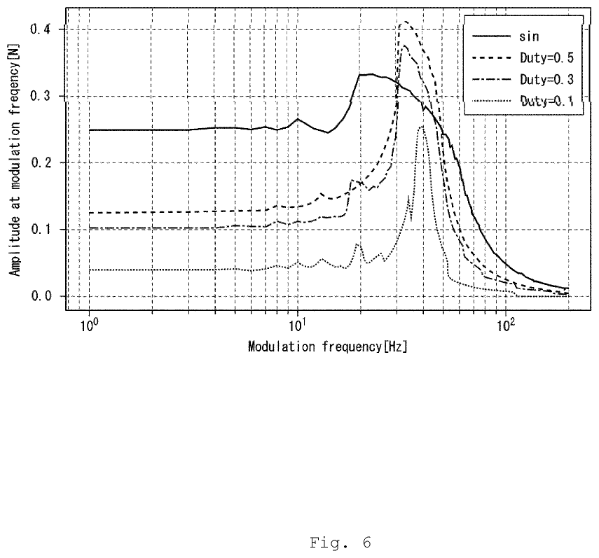

FIG. 6 is a second diagram showing an example of experimental results in the embodiment. A horizontal axis of FIG. 6 shows a “Modulation frequency”, and a vertical axis shows an “Amplitude at modulation frequency”. The unit of the horizontal axis is Hz. The unit of the longitudinal axis is Newton. The definition of the “Modulation frequency” is a switching frequency of the ultrasonic focal position and is an inverse of the unit period in ultrasonic irradiation. For example, if the Modulation frequency is 5 Hz, it means that the focal position has moved between the sound-absorbing material 21 and the displacement body 22 at 5 Hz. In this case, rectangular waves of 5 Hz are input to both the sound-absorbing material 21 and the displacement body 22.

The definition of “Amplitude at modulation frequency” is that the vibration amplitude obtained by simulation is Fourier transformed, and only the components of the Modulation frequency are extracted. For example, in FIG. 6, the value of Amplitude at modulation frequency when Modulation frequency=5 Hz, that is, the value of the vertical axis at 5 Hz in the horizontal axis is the amplitude (force) of the 5 Hz component of the vibration waveform obtained by simulation.

A “sin” of FIG. 6 means amplitude modulation with a sine wave, and is plotted for comparison as the most basic pattern in vibration presentation. Here, the amplitude modulation with a sine wave is to change the force of the ultrasonic waves at a fixed focal point. For example, when the sine wave modulation is performed at 5 Hz, 5 Hz vibration is applied to the displacement body 22. “duty=0.5” of FIG. 6 has the same meaning as “duty=0.5” of FIG. 5, “duty=0.3” has the same meaning as “duty=0.7” of FIG. 5, and “duty=0.1” has the same meaning as “duty=0.9” of FIG. 5.

The results of FIG. 6 shows that even in the case of “duty=0.1”, the maximum value of “Amplitude at modulation frequency” is 63% or more of the maximum value of “Amplitude at modulation frequency” in the case of “duty=0.5”. The case of “duty=0.1” is a case where the displacement body 22 is irradiated with ultrasonic waves to only 10% of the period.

Therefore, if it is simply compared only with the irradiated energy, it would be estimated that the magnitude of the mechanical stimulation in the case of “duty=0.1” would be 20% or less of that in the case of “duty=0.5”. However, the experimental results showed 63% which is a value three times equal to or greater than 20%. In this way, the experimental results show that when comparing ultrasound waves with different duty ratios, the difference in magnitude of mechanical stimulation due to the difference in duty ratios is less than the difference in the ratio indicated by the duty ratios.

### Example of Hardware Configuration of Stimulation Control Device 1

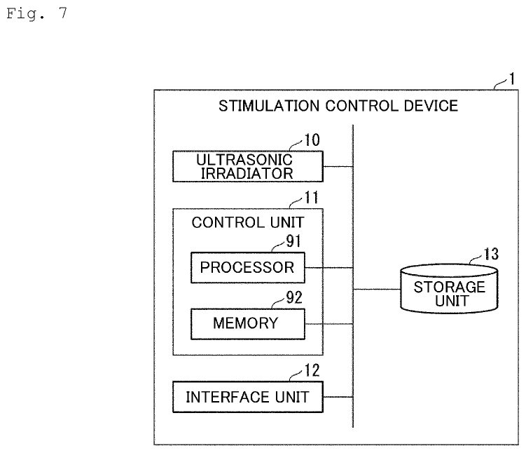

FIG. 7 is a diagram showing a more detailed example of the hardware configuration of the stimulation control device 1 in the embodiment. The stimulation control device 1 includes a control unit 11 including a processor 91 such as a CPU and a memory 92 connected through a bus, and executes a program.

The stimulation control device 1 functions as a device that includes the ultrasonic irradiator 10, the control unit 11, the interface unit 12, and the storage unit 13, by executing the program.

More specifically, the processor 91 reads out the program stored in the storage unit 13 and stores the read program in the memory 92. When the processor 91 executes the program stored in the memory 92, the stimulation control device 1 functions as a device that includes the ultrasonic irradiator 10, the control unit 11, the interface unit 12, and the storage unit 13.

The control unit 11 controls operations of the functional units included in the stimulation control device 1. The control unit 11 executes, for example, the transfer route control process. The control unit 11 acquires information stored in the storage unit 13, for example. Specifically, the processing for acquiring the information stored in the storage unit 13 is reading out.

The interface unit 12 is configured to include a communication interface for connecting the stimulation control device 1 to an external device. The interface unit 12 communicates with external devices via wired or wireless.

The interface unit 12 may be configured to include an input device such as a mouse, a keyboard, and a touch panel. The interface unit 12 may be configured as an interface for connecting these input devices to the stimulation control device 1. In this manner, the interface unit 12 accepts the input of various pieces of information for the stimulation control device 1 via the input device and wired or wireless communication.

The interface unit 12 outputs, for example, various types of information. The interface unit 12 is configured to include a display device such as a cathode ray tube (CRT) display, a liquid crystal display, or an organic electro-luminescence (EL) display. The interface unit 12 may be configured as an interface connecting these display devices to the stimulation control device 1. The interface unit 12 outputs, for example, information that is input to the interface unit 12.

The storage unit 13 is configured to use a computer-readable storage medium device (non-transitory computer-readable recording medium) such as a magnetic hard disk device or a semiconductor storage device. The storage unit 13 stores various types of information about the stimulation control device 1. The storage unit 13 stores various types of information generated by the operations of the control unit 11, for example. The storage unit 13 stores, for example, information acquired by the interface unit 12.

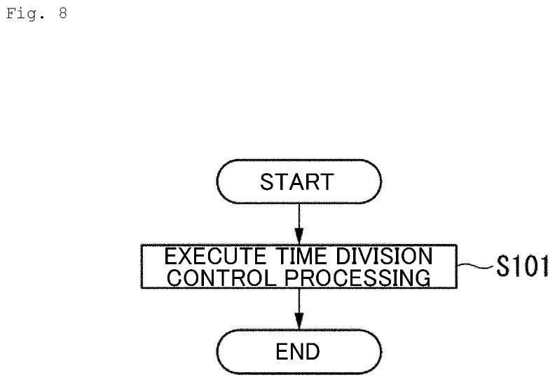

FIG. 8 is a diagram showing an example of a flow of processing executed by the stimulation control device 1 in the embodiment. The control unit 11 executes the time division control processing (step S101). Thus, heat and mechanical stimulation are presented to the presentation target.

The stimulation control device 1 configured in this manner includes a control unit 11 that executes the time division control processing. Thus, the stimulation control device 1 can present heat and mechanical stimulation by a passive one which is driven by ultrasonic waves.

### Modification Example

The control unit 11 may change the intensity, waveform, or propagation destination of the ultrasonic waves emitted by the ultrasonic irradiator 10 on the basis of the irradiation destination information. The irradiation destination information is information indicating each position or orientation of the sound-absorbing material 21 and the displacement body 22 viewed from the ultrasonic irradiator 10.

For example, when the sound-absorbing material 21 and the displacement body 22 are attached to the finger of the presentation target as in the example of FIG. 2, the position and orientation of the sound-absorbing material 21 and the displacement body 22 change in accordance with the movement of the finger. In such a case, the control unit 11 has a higher probability of presenting stimulation to the presentation target, than a case of not making any changes, by changing the intensity, waveform or propagation destination of the ultrasonic waves in accordance with changes in the position or orientation of the sound-absorbing material 21 and the displacement body 22 viewed from the ultrasonic irradiator 10.

Accordingly, the control unit 11 may change the intensity, waveform, or propagation destination of the ultrasonic waves emitted by the ultrasonic irradiator 10 on the basis of the irradiation destination information. Specifically, the control unit 11 determines the intensity, waveform or propagation destination of the ultrasonic waves on the basis of the irradiation destination information, by the use of information (hereinafter referred to as “relationship information”) indicating a relationship between each position or orientation of the sound-absorbing material 21 and the displacement body 22 viewed from the ultrasonic irradiator 10 and the intensity, waveform or propagation destination of the ultrasonic waves. The control unit 11 causes the ultrasonic irradiator 10 to emit the ultrasonic waves of the determined intensity, waveform or propagation destination. In this manner, the control unit 11 changes the intensity, waveform, or propagation destination of the ultrasonic waves emitted by the ultrasonic irradiator 10 on the basis of the irradiation destination information.

The relationship information may be, for example, a data table that defines a relationship between each position or orientation of the sound-absorbing material 21 and the displacement body 22 viewed from the ultrasonic irradiator 10 and the intensity, waveform, or propagation destination of the ultrasonic waves. The relationship information may be a predetermined function, for example, in which each position or orientation of the sound-absorbing material 21 and the displacement body 22 viewed from the ultrasonic irradiator 10 is an independent variable, and the intensity, waveform or propagation destination of the ultrasound is a dependent variable. The relationship information may be a mathematical model that has been learned by machine learning in advance, and may be a mathematical model that estimates the intensity, waveform, or propagation destination of the ultrasonic waves on the basis of each position or orientation of the sound-absorbing material 21 and the displacement body 22 viewed from the ultrasonic irradiator 10.

The irradiation destination information may be obtained by any technology as long as it is capable of acquiring the position or orientation of the sound-absorbing material 21 and the displacement body 22. For example, the irradiation destination information may be obtained on the basis of the time series of the results of imaging of the ultrasonic irradiator 10, the sound-absorbing material 21, and the displacement body 22 by a camera. In such a case, since the time series of the imaging results indicates a change in the position or direction of the sound-absorbing material 21 and the displacement body 22 viewed from the ultrasonic irradiator 10, the irradiation destination information can be obtained on the basis of the time series of the imaging results.

For the positions of the sound-absorbing material 21 and the displacement body 22, for example, when a global positioning system (GPS) transmitter is attached to the sound-absorbing material 21 and the displacement body 22, position information of the sound-absorbing material 21 and the displacement body 22 viewed from the ultrasonic irradiator 10 may be obtained by the GPS. If the position of the ultrasonic irradiator 10 does not change, it is not necessary to install a GPS oscillator on the ultrasonic irradiator 10, but if the position of the ultrasonic irradiator 10 changes, the GPS oscillator may also be installed on the ultrasonic irradiator 10.

In the case where the stimulation system 100 is used so that the position and orientation of the sound-absorbing material 21 and the displacement body 22 viewed from the ultrasonic irradiator 10 do not change, it is not necessary to use the irradiation destination information.

Although the acquisition of the irradiation destination information by the control unit 11 may be performed in any way as long as the irradiation destination information can be acquired, for example, the control unit 11 may acquire the irradiation destination information transmitted from the transmission source of the irradiation destination information via the interface unit 12. Further, the control unit 11 itself may acquire the irradiation destination information from the imaging result by performing calculation on the basis of, for example, the imaging result of the camera. In this case, the control unit 11 obtains the imaging result by the camera from the camera via the interface unit 12.

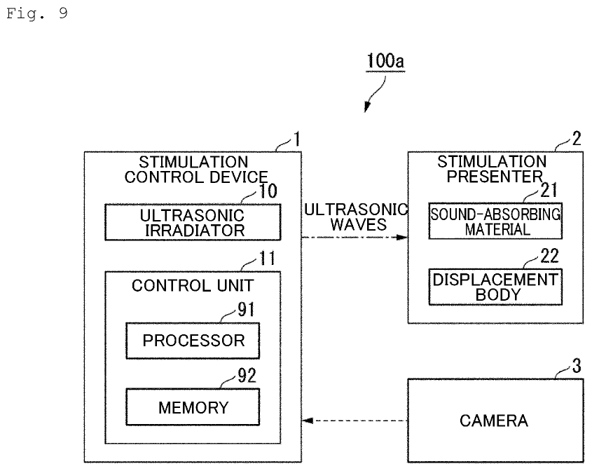

FIG. 9 is a diagram showing an example of a configuration of a stimulation system 100a according to a modified example. In addition, the stimulation system 100a differs from the stimulation system 100 in that it includes a camera 3. The camera 3 is a camera that images the sound-absorbing material 21 and the displacement body 22. In the stimulation system 100a, the control unit 11 obtains irradiation destination information on the basis of the imaging result by the camera 3.

In acquiring the irradiation destination information based on the imaging result of the camera 3, for example, segmentation of the imaging result of the camera 3 is executed to obtain information indicating where in the image the sound-absorbing material 21 and the displacement body 22 are imaged. Next, the position and orientation of the sound-absorbing material 21 and the displacement body 22 are estimated on the basis of information indicating values of internal and external parameters of the camera 3, information indicating the position and orientation of the ultrasonic irradiator 10, and the result of the segmentation.

The stimulation control device 1 may be implemented by the use of a plurality of information processing devices that are communicably connected via a network. In this case, each processing executed by the control unit 11 may be distributed and executed in the plurality of information processing devices.

Note that all or some of the functions of each of the control unit 11, the interface unit 12 and the storage unit 13 may be implemented, using hardware such as an application specific integrated circuit (ASIC), a programmable logic device (PLD), or a field programmable gate array (FPGA). The program may be recorded on a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via telecommunication lines.

Although an embodiment of the present invention has been described in detail above with reference to the drawings, the specific configuration is not limited to this embodiment, and designs that do not deviate from the gist of the present invention are also included.

### REFERENCE SIGNS LIST

100, 100a Stimulation system
1 Stimulation control device
2 Stimulation presenter
3 Camera
10 Ultrasonic irradiator
11 Control unit
12 Interface unit
13 Storage unit
21 Sound-absorbing material
22, 22-a, 22-b Displacement body
101 Ultrasound vibrator
91 Processor
92 Memory

1. A stimulation control apparatus comprising:
an ultrasonic irradiator which emits ultrasonic waves to a stimulation presenter including a sound-absorbing material which is a passive one and absorbs ultrasonic waves and releases heat, and a displacement body which is a passive one and is at least partially displaced upon receiving the ultrasonic waves; and
a processor;
a storage medium having computer program instructions stored thereon, wherein the computer program instructions, when executed by the processor, perform processing of:
a controlling of the ultrasonic irradiator
wherein the ultrasonic irradiator is controlled to irradiate the sound-absorbing material with the ultrasonic waves in a partial period of a predetermined unit period and to irradiate the displacement body with the ultrasonic waves in another partial period of the unit period.

2. The stimulation control apparatus according to claim 1,
wherein the ultrasonic irradiator is controlled, on the basis of irradiation destination information that is information indicating each position or orientation of the sound-absorbing material and the displacement body viewed from the ultrasonic irradiator, in the control of the ultrasonic irradiator.

3. A stimulation control method executed by a stimulation control apparatus which includes an ultrasonic irradiator which emits ultrasonic waves to a stimulation presenter including a sound-absorbing material which is a passive one and absorbs ultrasonic waves and releases heat, and a displacement body which is a passive one and is at least partially displaced upon receiving the ultrasonic waves; and a processor; a storage medium having computer program instructions stored thereon, wherein the computer program instructions, when executed by the processor, perform processing of:
controlling the ultrasonic irradiator, the method comprising
controlling the ultrasonic irradiator to irradiate the sound-absorbing material with the ultrasonic waves in a partial period of a predetermined unit period and to irradiate the displacement body with the ultrasonic waves in another partial period of the unit period.

4. A stimulation presenter comprising:
a sound-absorbing material which is a passive one and absorbs ultrasonic waves and releases heat; and
a displacement body which is a passive one and is at least partially displaced upon receiving the ultrasonic waves.
